(19) United States
(12) Patent Application Publication
(10) Pub. No.: US 2026/0017234 A1
(43) Pub. Date: Jan. 15, 2026

(54) Temporary Contacts Management

(71) Applicant: DISH Network Technologies India Private Limited, Bangalore (IN)

(72) Inventors: Vikram Balarajashetty, Bangalore (IN); Visali Manoharan, Vanagaram (IN); Manasa Jami, Madhurawada (IN); Dileep Puramana, Wandoor (IN)

(73) Assignee: DISH Network Technologies India Private Limited, Bangalore (IN)

(21) Appl. No.: 18/768,333

(22) Filed: Jul. 10, 2024

(51) Int. Cl. G06F 16/16; G06F 16/11

(52) U.S. Cl. CPC G06F 16/162; G06F 16/125

(57) ABSTRACT

Devices, systems, computer readable mediums, and processes for managing user contact data on a user device on a permanent, temporary, time-based, or other basis are described. A user device may include a data store storing first computer instructions for instantiating a user device contacts application and a user device temporary contacts plug-in which configures the user device (UD) to perform temporary contact management operations (UD-TCMOs) that include designating user contact data (UCD) received from a second UD for later deletion. For an implementation, a user may manually designate the UCD as temporary contact data (TCD). The TCD identifies a condition precedent specifying when the UCD is to be deleted, such as after passage of a given period or a calendar event. The TCD may be received from a network server. A temporary data flag (TDF) may be set. The TDF identifies instances of data in the UCD as TCD.

### TECHNICAL FIELD

The technology described herein generally relates to devices, systems, and processes by which a given user may manage storage and utilization of one or more contact files on a user device on a permanent, temporary, time-based, or other basis.

### BACKGROUND

A given user commonly encounters many persons and other devices and systems in the course of one's day-to-day dealings with whom the given user may desire later to communicate on a temporary, limited period, or other basis. For example, the given user may encounter a human technician, e.g., a plumber, with whom the given user may need to communicate while the plumber attends to a given task or activity (e.g., repairing a garbage disposal or the like). To facilitate such communications, the plumber may provide contact information to the given user, and visa-versa. The contact information may include any information by which communications between the plumber and the given user may be facilitated, such as phone number, email address, or the like. The plumber and the given user may store such contact information in a “contact file” that may be maintained in an electronic device (e.g., on a smart phone) or otherwise. Once the given task or activity is complete, the contract information for the other party (e.g., the plumber's contact information as stored by the user or vice versa) may no longer be needed.

Yet, user typically forget to delete such contact information which results, over time, into contact file depositories that may contain numerous unneeded contact files. Further, when contact files are stored on applications, such as WHATAPP, wherein a stored contact may also have access to a user's status, location and/or other information, the on-going storage of unneeded contact files may present privacy and/or security concerns.

Accordingly, devices, systems and processes are needed which address the above and other issues regarding storage of contact files (and the like) for other “entities” (as defined below) with respect to which a given user has a “temporary” (as defined below) need to maintain for later access thereof.

### SUMMARY

Various implementations are described of devices, systems, and processes by which a given user may manage storage and utilization of one or more contact files, for one or more entities, on a permanent, temporary, time-based, or other non-permanent basis.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

For at least one implementation of the present disclosure, a user device includes a user device data store (UDDS) that non-transitorily stores first computer instructions for instantiating a user device contacts application (UD-ContactsApp) and second computer instructions for instantiating a user device temporary contacts application (UD-Temp). The user device includes a user device processor (UDP) coupled to the UDDS. The UDP, when executing the first computer instructions, may instantiate the UD-ContactsApp which further configures the user device (UD) to perform user device contact operations (UDCOs). The UDP, when executing the second computer instructions, may instantiate the UD-Temp which further configures the UD to perform user device temporary contact management operations (UD-TCMOs). The UD-TCMOs may include designating user contact data (UCD), received by the UD from a second user device (2UD), for deletion at a future time.

For at least one implementation, a user of the UD may manually designate the UCD as temporary contacts data (TCD) which identifies at least one condition precedent specifying when the UCD is to be deleted. For at least one implementation, the at least one condition precedent may be a passage of a given period. For at least one implementation, the UD-TCMOs may further include receiving, from a network contacts server (NCS), TCD designating the UCD for automatic deletion.

For at least one implementation, the UDCOs may include generating at least one user device user contact file (UD-UCF) that includes one or more data fields for the UCD. The UD-TCMOs may further include configuring the UD-ContactsApp to include a data field for setting, in the UD-UCF, a temporary data flag (TDF) that identifies at least one instance of data in the UCD as TCD. For at least one implementation, the UD-TCMOs may include setting the TDF in the UD-UCF.

For at least one implementation, the UD-TCMOs may include configuring the UDDS to manage the UD-TCF. The UD-TCF may include TCD that is associated with the TDF. The TCD may further identify at least one condition precedent specifying when the UCD is to be deleted. The at least one condition precedent may be predetermined. The user may set the at least one condition precedent upon receiving the UCD. The at least one condition precedent may identify a future data and the future time. The at least one condition precedent may be determined prior the UD receiving the UCD from the 2UD. The at least one condition precedent may identify a calendar event. The UD-TCMOs may include automatically deleting the UCD when the future calendar event has occurred.

For at least one implementation, the UD-TCMOs may include receiving, from an NCS, a designation of the UCD as TCD. The NCS may utilize an NCS model (NCS-Model) to identify the UCD as TCD. The NCS-Model may be generated using one or more NCS neural processing units utilizing artificial intelligence and machine learning. The NCS-Model may be initially trained, during an initial training period, by monitoring utilization, disseminations, and deletions of the UCD by multiple other user devices, in a user set, over an initial monitoring period. The NCS-Model may undergo refinement training, after the initial monitoring period, by monitoring responses, by users of the multiple user devices, to queries of whether the UCD is to be designated or remain designated as TCD.

For at least one implementation of the present disclosure, a non-transitory computer readable medium, having stored thereon computer instructions which, when executed by a UDP, may instantiate a UD-Temp that configures a UD to perform UD-TCMOs that may include receiving UCD from a 2UD, determining whether the UCD includes TCD, and when the UCD includes the TCD, deleting the TCD when a condition precedent occurs.

For at least one implementation, the condition precedent may be a passage of a period of time. For at least one implementation, when the UCD may include TCD, and the UD-TCMOs may include identifying a UCD-UCF corresponding to the UCD and setting a TDF in the UCD-UCF.

For at least one implementation, the non-transitory computer readable medium may have stored thereon additional computer instructions which, when executed by the UDP, instantiates a UD-ContactsApp that configures the UD to perform UDCOs. The UDCOs may include storing the UCD in a UD-UCF and managing the UD-UCF. The UD-UCF may include at least one data field identifying at least one user characteristic. The UD-TCMOs may further include identifying the UD-UCF corresponding to the UCD and setting a TDF in the UD-UCF. The TDF may correspond to a TCF that identifies at least one condition precedent and, upon occurrence of the condition precedent, the UD-Temp may instruct the UD-ContactsApp to delete the UCD corresponding to the TCF. The TCF may be stored by a network contacts server coupled to the UD.

For at least one implementation, a process may include receiving UCD at a 1UD from a 2UD, determining whether the UCD is to be temporarily stored by the 1UD and, when temporarily stored: setting a TDF for the UCD; specifying a value for TCD associated with the TDF; storing the TCD in a TCF; adding the TDF to the UCD; and storing the UCD in a user device user contact file. The TCD may specify a condition precedent. Upon an occurrence of the condition precedent, the UCD may be deleted from the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an implementation of a temporary contacts management system and in accordance with at least one implementation of the present disclosure.

FIG. 2 is a flow chart illustrating a process by which a user device performs one or more temporary contact management operations and in accordance with at least one implementation of the present disclosure.

FIG. 3 is a flow chart illustrating a process by which a network contact server monitor performs network contact management operations in accordance with at least one implementation of the present disclosure.

FIG. 4 is a flow chart illustrating a process for managing temporary contact and in accordance with at least one implementation of the present disclosure.

### DETAILED DESCRIPTION

Various implementations of the present disclosure describe devices, systems, and processes by which a given user may manage storage and utilization of one or more contact files on a user device on a permanent, temporary, time-based, or other basis.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Application” (which are also commonly referred to as a “computer program”) herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like. For at least one implementation, an application may be configured as, include, and/or utilize a “plug-in” (as described below).

“AI/ML” (Artificial Intelligence/Machine Learning) herein refers to the use of one or more supervised learning, unsupervised learning, and/or refinement learning processes (as executed by one or more processors which may include processors associated with one or more neural networks) to perform one or more of the operations of the various computer engines described herein.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Bus” herein refers to any known and/or later arising technologies which facilitate the transfer of data within and/or between components of a device. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating AET functions. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazom.com Inc., AZURE provided by Microsoft Corp., and others.

“Component” herein refers to a Module of a Device, as further defined herein.

“Computer Data” herein refers to Data, as further defined herein.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Computer instruction” herein refers to an Instruction, as further defined herein.

“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.

“Content” herein refers to data that that may be presented, using a suitable presentation device, to a user in a humanly perceptible format. When presented to a human, the data becomes “information.” Non-limiting examples of content include images and graphics such as those related to television programs, streaming video, music, or otherwise. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized. Content may identify artists, events, venues or the like.

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in one or more of a cache, a memory, a data storage device, or otherwise, the given data packet has a non-transient state. For example, and not by limitation, data may take any form including as one or more applications, content, or otherwise. Instructions, as further described herein, are a form of data.

“Data store” herein refers to any device or combinations of devices, and/or components of a device, combinations of components of one or more devices, or the like configured to store data on a temporary, permanent, non-transitory, or other basis. A data store is also referred to herein as a “computer readable medium” and/or a “non-transitory computer readable medium.” A data store may store data in any form, such as electrically, magnetically, physically, optically, or otherwise. A data store may include a cache on a processor, memory devices, with non-limiting examples including random access memory (RAM) and read only memory (ROM) devices, and the like. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising data storage device technologies may be utilized for a given data store. Available storage provided by a given one or more data stores may be partitioned or otherwise designated by a storage controller as providing for permanent storage and temporary storage. Non-transitory data, computer instructions, or other the like may be suitably stored in a data store permanently or temporarily. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transitory storage of data. Permanent storage and/or temporary storage may be used to store data which, while communicated may be transitory or non-transitory, but while stored, is defined herein to be a form of non-transitory data.

“Device” herein refers to any known or later arising electrical device configured to, singularly and/or in combination, communicate, manipulate, output (e.g., for presentation as information to a human), process, store, or otherwise utilize data. Non-limiting examples of devices include User Devices, Set Top Boxes, and Servers.

“Fixed Device (FD)” herein refers to a device, which is not associated with a user but with respect to which contact information may be needed to utilize one or more features and/or functions provided by and/or accessible via the device. A non-limiting example of a fixed device is an access control panel which, in order to gain access to a controlled area, a user needs to provide data identifying the user and/or generic access codes, or the like.

“Instruction” (which is also referred to herein as a “computer instruction”) herein refers to a non-transitory processor executable instruction, associated data structures, sequence of operations, program modules, or the like. An instruction is described by an instruction set. It is commonly appreciated that instruction sets are often processor specific and accordingly an instruction may be executed by a processor in a language format (e.g., a machine language format) that is translated from a higher level programming language (e.g., C++). An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient, non-transient, transitory and/or non-transitory basis, as may arise for any given data, content and/or instruction. While the data for one or more instructions is being utilized, such use is herein deemed to occur on a non-transient and non-transitory basis.

“Module” herein refers to and, when claimed, recites definite structure for a device that is configured to provide at least one feature and/or output signal and/or perform at least one function including one or more of the features, output signals and functions described herein. A module may provide the one or more functions using computer engines, processors, computer instructions, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module. Likewise, a POSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.

“Plug-in” (which are also commonly referred to as an “add-on” by the MOZILLA foundation and as an “add-in” by MICROSOFT), herein refers to one or more computer instructions that are provided as a software component that adds one or more specific features to an existing application. For at least one implementation of the present disclosure, a plug-in may utilize services provided by a host application. The plug-in typically registers with the host application and a protocol is utilized by which data may be exchanged by and between the host application and the plug-in. For at least one implementation, a plug-in may be implemented as a shared library which gets dynamically loaded when a corresponding host application is instantiated.

“Power Supply/Power” herein refers to any known or later arising technologies which facilitate the providing to and/or use by a device of electrical power. Non-limiting examples of such technologies include batteries, power converters, inductive charging components, line-power components, solar power components, and otherwise.

“Processor” herein refers to one or more known and/or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, multi-threaded, and otherwise.

“Security Component/Security Module/Security” herein refers to any known or later arising components, processors, computer instructions, modules, and/or combinations thereof configured to secure data as communicated, processed, stored, output for presentation to a user, or otherwise manipulated. Non-limiting examples of security components include those which implement encryption/decryption standards, such as an Advanced Encryption Standard (AET), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include content servers, database servers, file servers, application servers, web servers, communications servers, virtual servers, computing servers, and the like. Servers may be combined into clusters (e.g., a server farm), logically or geographically grouped, combined into neural networks, or otherwise configured and/or utilized. Any known or later arising technologies may be used for a server. A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Set Top Box” (STB) herein refers to one or more devices, servers, data stores, communications interfaces, and related components which, singularly and/or cooperatively, facilitate one or more content abridgement functions. As used herein, an “STB function” (STBF) is one or more data processing and/or communications operations performed by one or more STBs, which facilitate one or more features and functions of the present disclosure. An STB may include one or more processors, data stores, communications interfaces, user interfaces, busses, and related components. The STB components may be physically, logically, virtually or otherwise grouped and/or coupled to facilitate the one or more features and functions including, but not limited to, those identified herein.

“Substantially simultaneous(ly)” herein refers to an absence of a greater than expected and humanly perceptible delay between a first event or condition and a second event or condition. Substantial simultaneity may vary in a range of quickest to slowest expected delay, to a moderate delay, or to a longer delay. For at least one implementation, substantial simultaneity occurs within an acceptable delay (as described above).

“User” herein refers to one or more of a single person, a household of people (such as those in a family), a collection of people (e.g., those in a fraternal organization or a club), or any other association of one or more human beings. A given household may have multiple users and/or collections of users (e.g., parents being one collection of users with children being a second collection of users in a household).

“User Device (UD)” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user and convert information to data and vice versa. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Temporary Contacts Management System (“TCMS”) 100

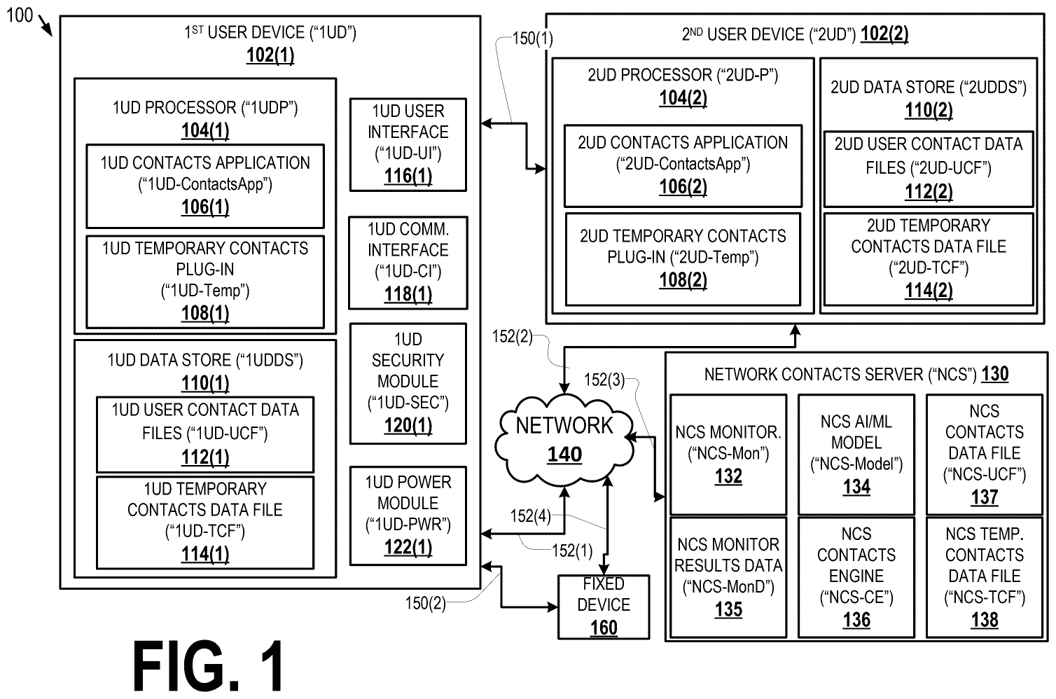

As shown in FIG. 1 and for at least one implementation of the present disclosure, a temporary contacts management system (TCMS) 100, may include one or more combinations and/or permutations of: at least one user device (UD) 102 which for at least one implementation may include a first user device (1UD) 102(1) and a second user device (2UD) 102(2); a network contacts server (NCS) 130; a fixed device (FD) 160; a network 140, which for at least one implementation may be implemented using a Cloud based network; one or more direct couplings (DC)150, such as a first direct coupling 150(1) which couples the 1UD 102(1) with the 2UD 102(2), and a second direct coupling 150(2), which couples the 1UD 102(1) with the fixed device 160; and one or more network based couplings (NBC) 152, such as a first NBC 152(1) coupling the 1UD 102(1) to the network 140, a second NBC 152(2) coupling the 2UD 102(2) to the Network 140, a third NBC 152(3) coupling the NCS 130 to the Network 140, and a fourth NBC 152(4) coupling the FD to the Network 140. It is to be appreciated that a given direct coupling (DC) and/or Network based coupling (NBC) may utilize any coupling for a given implementation of the present disclosure.

### User Device (UD) 102

As further shown in FIG. 1, a UD 102 may be configured to include a user device processor (UDP) 104, such as a first user device processor (1UDP) 104(1) and a second user device processor (2UDP) 104(2).

The UDP 104 may be configured to execute first computer instructions which instantiate a user device contact application (UD-ContactsApp) 106, and which configures a given UD 102 to perform one or more UD contact operations (UDCOs). As shown, a first user device contacts application (1UD-ContactsApp) 106(1) and a second user device contact application (2UD-ContactsApp) 106(2) may be instantiated by the respective UDPs 104. Non-limiting examples of UD-ContactsApps include features provided by MICROSOFT OUTLOOK, GOOGLE CONTACTS, and the like. As is commonly known by a PHOSITA, non-limiting examples of UD contact operations include, but are not limited to, the entry, access, management and the like of data (herein, “user contact data (UCD)”) into one or more contact files where the contact files include one or more data field that identifies one or more “user characteristics”, “device characteristics,” or the like with non-limiting examples of user characteristics including: a user's name, address, email address, work title, employer, phone number(s) including office, mobile and facsimile, related web page(s), image, business card, category (e.g., family, business, medical, etc.), certifications, and the like. As is commonly known, user contact data may be shared directly or indirectly between user devices using known technologies such as email, text message, voice message, manual data entry, nearby share (using, e.g., Near Field Communications technologies), and the like.

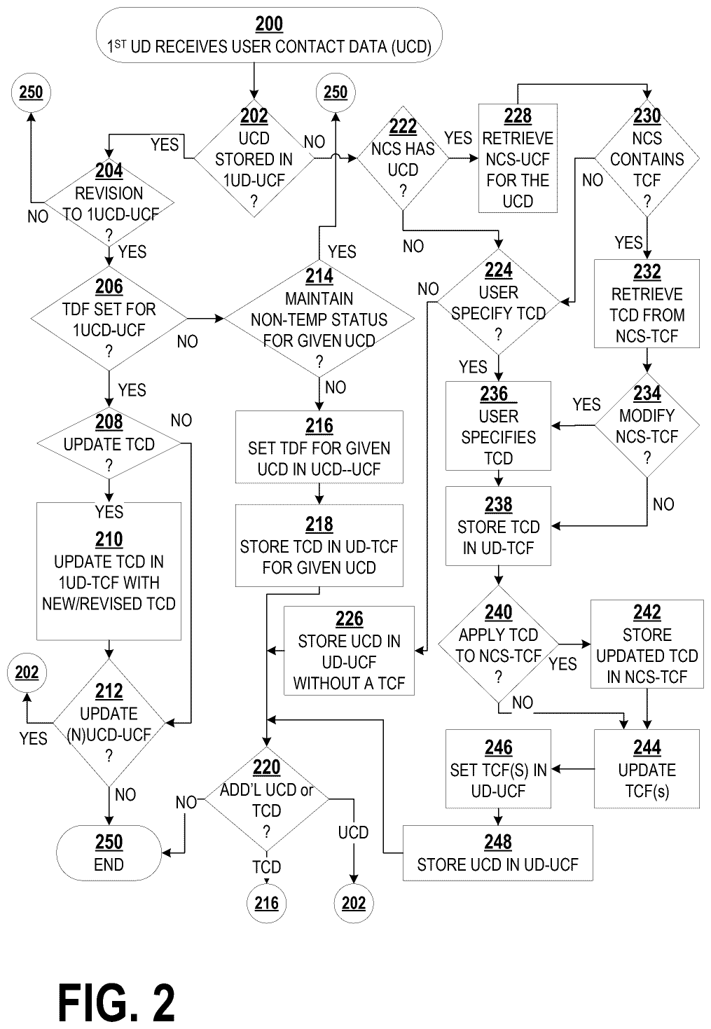

The UDP 104 may be further configured to execute second computer instructions which instantiate a user device temporary contact application (UD-Temp) 108, and which configures a given UD 102 to perform one or more UD temporary contact management operations (UD-TCMOs), which are described below with reference to FIG. 2. As shown, a first user device temporary contact application (1UD-Temp) 108(1) and a second user device temporary contact application (2UD-Temp) may be instantiated by the respective UDPs 104. For at least one implementation, the UD-Temp 108 may be part of the UD-ContactsApp 106. In other implementations, the UD-Temp 108 may operate as a plug-in modifying the operation of the UD-ContactsApp 106.

A UD 102 may include a user device data store (UDDS) 110, such as a first user device data store (1UD-DS) 110(1) and a second user device data store (2UD-DS) 110(2). A UDDS 110 may be configured as one or more “data stores,” as defined above. The UDSSs 110 may be configured to organize data into one or more data files, data structures, or the like (herein individually and/or collectively, a “data file”). For at least one implementation, the UD 102 may be configured to store user contact data (UCD) in one or more user contact files (UD-UCF) 112, such as a first user device user contact file (1UD-UCF) 112(1) and a second user device user contact file (2UD-UCF) 112(2). For at least one implementation, data stored in the UD-UCF 112 may be managed by a 1UD-ContactsApp 106 utilized by a given user device 102.

For at least one implementation, a UD 102 may be configured to store, in one or more data fields in a UD-UCF 112, one or more temporary data flags (TDFs) that identify one or more instances of data in the UD-UCF 112 as containing “temporary contact data.” As used herein, “temporary contact data (TCD)” identifies at least one condition precedent specifying when one or more instances of UCD are to be deleted. For at least one implementation, such one or more conditions may be predetermined and/or later determined (including conditions determined on a real-time basis). Non-limiting examples of a predetermined condition include a preset future date and/or a future time, or passage of a determined period, where the predetermined period begins with an entry of the TCD into a given UD-UCF. A non-limiting example of a later determined condition is an event that is associated with TCD being cancelled, or otherwise.

The one or more TDFs may be associated with TCD stored in one or more user device temporary contact files (UD-TCF) 114, such as a first user device temporary contacts file (1UD-TCF) 114(1) and a second user device temporary contacts file (2UD-TCF) 114(2). For at least one implementation, the UD-Temp configures the UD-DS to store at least one UD-TCF. Data stored in the UD-TCF 114 may be utilized by the UD-Temp 108, instantiated by a given UD 102, to manage access, deletion, and one or more other instances of UCD stored in a UD-UCF 112 of a given user device 102.

A UD 102 may include a user interface (UD-UI) 116, such as a first user device user interface (1UD-UI) 116(1) and a second user device user interface (2UD-UI) 116(2). A UD-UI 116 may be configured as one or more user interfaces, as defined above.

A UD 102 may include a communications interface (UD-CI) 118, such as a first user device communications interface (1UD-CI) 118(1) and a second user device communications interface (2UD-CI) 118(2). A UD-CI 118 may be configured as one or more communications interfaces, as defined above.

A UD 102 may include a security module (UD-SEC) 120, such as a first user device security module (1UD-SEC) 120(1) and a second user device security module (2UD-SEC) 120(2). A UD-SEC 120 may be configured as one or more security modules, as defined above.

A UD 102 may include a power module (UD-PWR) 124, such as a first user device power module (1UD-PWR) 122(1) and a second user device power module (2UD-PWR) 122(2). A UD-PWR 122 may be configured as one or more power modules, as defined above.

A UD 102 may be configured to include other modules, components, engines, applications, data stores, data files that are presently available and/or later available for use in a given user device 102 to facilitate the performance of one or more operations by the user device 102, a collection of user devices, 102, a system to which a given user device 102 may be coupled, or otherwise.

As shown in FIG. 2 and for at least one implementation of the present disclosure, a UD-Temp 108 may be configured to perform one or more operations which facilitate management of temporary contacts.

As per Operation 200 and for at least one implementation, the UD-TCMOs may begin with a given UD 102, such as the first UD 102(1), receiving contact data from another UD 102(N), such as the second UD 102(2). The contact data may be provided in a humanly readable form as contact information, in a device readable form, and/or as combinations thereof.

As per Operation 202 and for at least one implementation, the UD-TCMOs may include determining if the UCD is already stored in the 1UD-UCF. If “YES,” the process may proceed to Operation 204. If “NO,” the process may proceed to Operation 222.

As per Operation 204 and for at least one implementation, the UD-TCMOs may include determining if a revision to the already stored 1UD-UCF is specified by the received UCD? If “YES,” the process may proceed to Operation 206. If “NO,” the process may proceed to Operation 250 and ends with respect to the UCD received per Operation 200.

As per Operation 206 and for at least one implementation, the UD-TCMOs may include determining if a TDF has been set in the 1UD-UCF. If “YES,” the process may proceed to operation 208. If “NO,” the process may proceed to Operation 214.

As per Operation 208 and for at least one implementation, the UD-TCMOs may include determining if TCD associated with the 1UD-UCF needs to be updated in view of the received UCD. If “YES,” the process may proceed to Operation 410. If “NO,” the process may proceed to Operation 212.

As per Operation 210 and for at least one implementation, the UD-TCMOs may include updating the TCD associated with the 1UD-TCF with any new or revised TCD.

As per Operation 212 and for at least one implementation, the UD-TCMOs may include determining if another UD-UCF is to be updated. It is to be appreciated that this operation may occur, e.g., when a given UD is receiving UCDs that relate to multiple UCFs, such as when an office location applicable to multiple users changes and UCD for each of such multiple users is to be updated. If “YES,” the process may repeat Operation 202 with respect to a next UD. If “NO,” the process may proceed to Operation 250 and end.

As per Operation 214 and for at least one implementation, the UD-TCMOs may include determining whether to maintain a non-temporary status for the given UCD. If “YES,” the process may proceed to Operation 250 and end. If “NO,” the process may proceed to Operation 216.

As per Operation 216 and for at least one implementation, the UD-TCMOs may include setting at least one TDF for the given UCD in the UCD-UCF.

As per Operation 218 and for at least one implementation, the UD-TCMOs may include storing the TCD in the UD-TCF for the given UCD.

As per Operation 220 and for at least one implementation, the UD-TCMOs may include determining if an additional UCD or TCD is to be analyzed for updating, storing, generation or otherwise. If “NO,” the process may proceed to Operation 250 and end. If “UCD,” the process may proceed to Operation 202. If “TCD,” the process may proceed to Operation 216.

As per Operation 222 and for at least one implementation, the UD-TCMOs may include determining if the NCS has already stored the UCD received per Operation 200. If “YES,” the process may proceed to Operation 228. If “NO,” the process may proceed to Operation 224.

As per Operation 224 and for at least one implementation, the UD-TCMOs may include determining if the user desires to specify a TCD. If “YES,” the process may proceed to Operation 236. If “NO,” the process may proceed to Operation 226.

As per Operation 226 and for at least one implementation, the UD-TCMOs may include storing the UCD received per Operation 200 without a TCF.

As per Operation 228 and for at least one implementation, the UD-TCMOs may include retrieving, from the NCD, the NCS-UCF associated with the UCD received per Operation 200.

As per Operation 230 and for at least one implementation, the UD-TCMOs may include determining if the NCS-UCF retrieved from the NCD, as per Operation 228, contains one or more TCFs. If “YES,” the process may proceed to Operation 232. If “NO,” the process may proceed to Operation 224.

As per Operation 232 and for at least one implementation, the UD-TCMOs may include retrieving the one or more TCDs stored by the NCS from the NCS-TCF.

As per Operation 234 and for at least one implementation, the UD-TCMOs may include determining whether a modification is to be made to the NCS-TCF. If “YES,” the process may proceed to Operation 236. If “NO,” the process may proceed to Operation 238.

As per Operation 236 and for at least one implementation, the UD-TCMOs may include the user specifying one or more TCDs for the UCD received per Operation 200.

As per Operation 238 and for at least one implementation, the UD-TCMOs may include storing the TCD(s) specified per Operation 236 in the UD-UCF.

As per Operation 240 and for at least one implementation, the UD-TCMOs may include determining whether to apply the TCD(s) specified by the user per Operation 236 to the NCS-TCF. If “YES,” the process may proceed to Operation 242. If “NO,” the process may proceed to Operation 244.

As per Operation 242 and for at least one implementation, the UD-TCMOs may include storing the one or more updated TCDs in the NCS-TCF.

As per Operation 244 and for at least one implementation, the UD-TCMOs may include updating one or more of the TCFs in view of the one or more user specified TCDs, as specified per Operation 236.

As per Operation 246 and for at least one implementation, the UD-TCMOs may include setting one or more of the TCFs in the UD-TCF.

As per Operation 248 and for at least one implementation, the UD-TCMOs may include storing the UCD in the UD-UCF. For at least one implementation, one or more of Operations 244-248 may be initiated in other UDs when the NCS-TCF is modified and the other UDs also contain a UCF that corresponds to and/or is associated with the UCD identified in the NCS-TCF. The process may then proceed to Operation 220 which is discussed above.

As per Operation 250 and for at least one implementation, the UD-TCMOs may end.

### Network Contacts Server (NCS) 130

As further shown in FIG. 1, the TCMS 100 may include at least one NCS 130. For at least one implementation, the NCS 130 may be provided by one or more AWS, GOOGLE, MICROSOFT or other Cloud based systems. Such Cloud based systems may be distributed, centralized, localized or otherwise provided. The NCS 130 may be configured to include one or more processors (not shown) configured to execute third computer instructions that, when executed by the NCS processors, instantiate an NCS Monitor (NCS-Mon) 132 and thereby perform one or more contact modeling operations by which UCD may be determined to contain or not contain TCD.

The NCS 130 processor(s) may be further configured to execute fourth computer instructions that instantiate an NCS contacts engine (NCS-CE) 136. The NCS-CE 136 may be configured to perform one or more network contact management operations and thereby manage in one or more data files, in one or more storage devices coupled to the NCS processor(s), where the storage device(s) store user contact data (UCD) in one or more NCS user contact data files (NCS-UCF) 137. For at least one implementation, data stored in the NCS-UCF 137 may mirror, or otherwise correspond to, UCDs stored in the one or more UD-UCFs 112(1)-(N) (where “N” is an integer). The NCS-CE 136 may be further configured to manage data files storing TDFs, with the TDFs being stored in one or more NCS temporary contact files (NCS-TCFs) 138.

### NCS Monitor (NCS-Mon) 132 and NCS Models (NCS-Mod) 134

For at least one implementation, the NCS-Mon 132 may use of one or more neural processing units (NPUs) that are further configured to utilize AI/ML to generate one or more NCS models (NCS-Model) 134. The NCS-Model 134 may be generated based on results generated during an initial training periods and as later refined by the NCS-Mon (NCS-MonD) 135. The NCS 130 may suitably store the NCS-MonD 135 in a data store coupled to the NCS 130 as one or more NCS Models (not shown). The NCS-Mon 132 may generate, refine and provide the NCS-Model 134 to the NCS-CE 136 for use therein in determining whether a given UCF and/or a given instance of UCD contains TCD.

For at least one implementation, the NCS-Model 134 may be generated by the NCS-Mon 132 based on actual utilizations, disseminations, deletions and the like of each of multiple users' contact data over a given initial training period and as later refined. For at least one implementation, the initial training period may include use of supervised training, wherein inputs provided in training the NCS-Model 134 and outputs from the model are verified by a human operator.

For another implementation, an initial training of an NCS-Model 134 may use unsupervised training. Such unsupervised training may be utilized when a given set of contacts are known to arise from a given source or type of contact. For example, an NCS-Model 134 utilized with respect to a set of truck drivers employed by a given shipping company (e.g., UPS, U.S. Postal Services, FED EX, DHS, AMAZON DELIVERY, or the like) may utilize unsupervised training as the nature of the contact data provided with a shipping company issued user device may be limited to use for official/shipping company purposes. Such limited uses may provide a higher confidence in any initial modeling of characterization of contact data for a truck driver for the given shipping company and based on such characterization how one or more of such contact data may be characterized as temporary contacts data with respect to one or more recipients thereof.

For at least one implementation, the NCS-Mon 132 may initially train the NCS-Model 134 by monitoring how each of an initial set of user devices are utilized (herein, the “user set”). The user set may be enlarged, reduced, changed (e.g., with different users) or otherwise modified as specified for a given implementation. For at least one implementation, such initial user set includes at least one thousand (1,000) user devices. The NCS-Mon 132 may further initially train the NCS-Model 134 by monitoring usage of the devices in the user set on the network 140 and specifically monitoring when a given user (of a given user device in the user set) determines that a given UCD and/or UCF does or does not contain TCD (in whole or in part).

Non-limiting examples of user device 102 usages that may be monitored include calls, emails, chats, calendar entries/deletions, location data, camera uses, microphone uses, search histories, and the like. For at least one implementation, any form, type, quantity and the like of usage data collectable by a given user device 102, when so permitted by a given user device, may be used by the NCS-Mon 132 to initially train and then refine the NCS-Model 134.

For at least one implementation, the NCS-Mon 132 may be configured to initially train (and refine thereafter) the NCS-Model 134 based on any given type, quantity, combination, permutation or the like of contact data associated with one or more, including each, of the user devices in the user set.

For at least one implementation, the unique users in the user set may opt-in or opt-out with respect to which type of contact data they are willing to allow the NCS-Mon 132 to access. Such participation may include granting of privileges to the NCS-Mon 132 to monitor how a given user's contact files, as stored on a given user device 102, in the Cloud, or otherwise, are utilized and managed over any given period of time, including indefinitely.

It is to be appreciated that a given user may be associated with multiple instances of contact data including, for example and not by limitation, personal contact data (e.g., their residence information) and business contact data (e.g., their employer, business location, title, and the like). A given user may also be associated with one or more instances of user demographic information that may be maintained in and/or with a given contact data file or otherwise. Non-limiting examples of such demographic data may include race, ethnicity, age, gender, hometown, and the like. Given the wide number of sources of contact data, for a given user, for at least one implementation, the NCS-Mon 132 may initially train the NCS-Model 134 based on one or more identifiable and/or otherwise quantifiable subsets of data provided in multiple instances of contact data files associated with a given user, such as business contact data (e.g., employer, employer address, employer phone number, employer provided phone number and email for the given user, and the like).

Upon identifying the initial user set of user contact data files to be monitored by the NCS-Mon 132 to initially train the NCS-Model 134, the NCS-Mon 132 may be configured to specify a period (herein, the “initial monitoring period”) during which the participating user's contact data files are to be monitored. For at least one implementation, the initial monitoring period may be six (6) months. As discussed above, a given user may agree to participate indefinitely, in which instance such participation may include the initial monitoring period and any follow-on monitoring period(s). Such periods may be continuous, periodic, scheduled, interrupted by a pause, cessation or the like of any determined length of time, or otherwise occur. Data arising from one or more follow on monitoring periods may be utilized to refine the NCS-Model 134.

The NCS-Mon 132 may be further configured to initially train (and/or later refine) the NCS-Model 134 by specifying what types of activities, vis-à-vis one or more UCFs associated with a given user set, are to be monitored. Non-limiting examples of such activities may include the dissemination (providing) of data in a UCF by electronic means, by manual entry, or otherwise. For a non-limiting example, a first user may convey their business phone number (a form of UCD) to second user using various means of data dissemination such as text message, phone call, voice mail, email, verbally, or otherwise. How such dissemination occurs may be informative of how such UCD is to be treated by the NCS-CE 136 (e.g., as non-TCD, TCD, or otherwise).

For at least one implementation, the NCS-Mon 132 may initially train (and/or later refine) the NCS-Model 134 by using a linear/polynomial regression algorithm, a random forest decision tree, or the like. As the NCS-Mon 132 collects the NCS-MonD 135 data, the NCS-Model 134 may identify which data from the NCS-MonD 135 to utilize in initially generating and later refining the NCS-Model 134. For example, a user (in the user set) who utilizes disseminates their business phone number to clients (e.g., of a service call) can be identified by the NCS-Mon 132, and the NCS-Model 134 accordingly trained, as having certain characteristics, such as the phone number being shared during a “working day” (i.e., Monday-Friday), during a standard time of business day (e.g., 7 am to 5 pm), and disseminated by one of email or text messaging, whether a calendar entry is included with the email or text message, and the like. The algorithm(s) used by the NCS-Mon 132 may further identify which of these characteristics are more likely or less likely to identify the given user's phone number as being temporary contact data, that the recipient thereof typically would use for a limited time and/or a limited purpose (e.g., in furtherance of the service call), or a non-temporary contact data that the recipient may desire to maintain for a non-temporary and/or longer period.

For at least one implementation, the NCS-Model 134 may be refined during subsequent use of the TCMS 100. For example, the UD-Temp 108 may be configured to present a pop-up on a visual display of a UD 102. The pop-up may include a check field or the like by which the user may be queried as to whether a given UD-UCF 112, and/or one or more data fields therein, is to be designated and/or remain designated as temporary contact data (TCD) or otherwise. The popup field may be associated with a prediction provided in the NCS-Model 134, as then existing. Based on the user's response to the popup, e.g., a user confirmation that the UD-UCF 112 (or data therein) is TCD, the prediction may be confirmed or unconfirmed. When confirmed, the NCS-Model 134 may increment a confidence interval or other statistical data value associated with the prediction. Likewise, the confidence interval may be decreased when a TCD prediction is not confirmed by a given user. For at least one interval, a confidence interval may be associated with each unique instance of NCS-MonD 135 utilized by the NCS-Mon 132 to refine an NCS-Model 134.

For at least one implementation, a confidence interval may be classified as “high” indicating that the UCD (and/or data field therein) is a TCD, “medium” indicating that a given UCD (and/or data field therein) may be a TCD and user confirmation or rejection is needed, or “low” indicating that a given UCD (and/or data field therein) is not TCD. For at least one implementation, a “high” confidence interval is equal to or above seventy-five percent (75%); a “medium” confidence interval is between thirty percent and seventy-five percent (30-75%), and a “low” confidence interval is equal to or below thirty percent (30%). Other confidence intervals may be used for other implementations to identify in a given NCS-Model 134 the predictive value of a given prediction therein as to whether a given UCF and/or UCD is or is not to be characterized as TCD.

### NCS Contacts Engine (NCS-CE) 136

For at least one implementation and as described above, the NCS 130 may be configured to include one or more processors (not shown) configured to execute fourth computer instructions that instantiate an NCS-CE 136 and thereby the NCS 130 performs one or more network contact management operations (NCMOs).

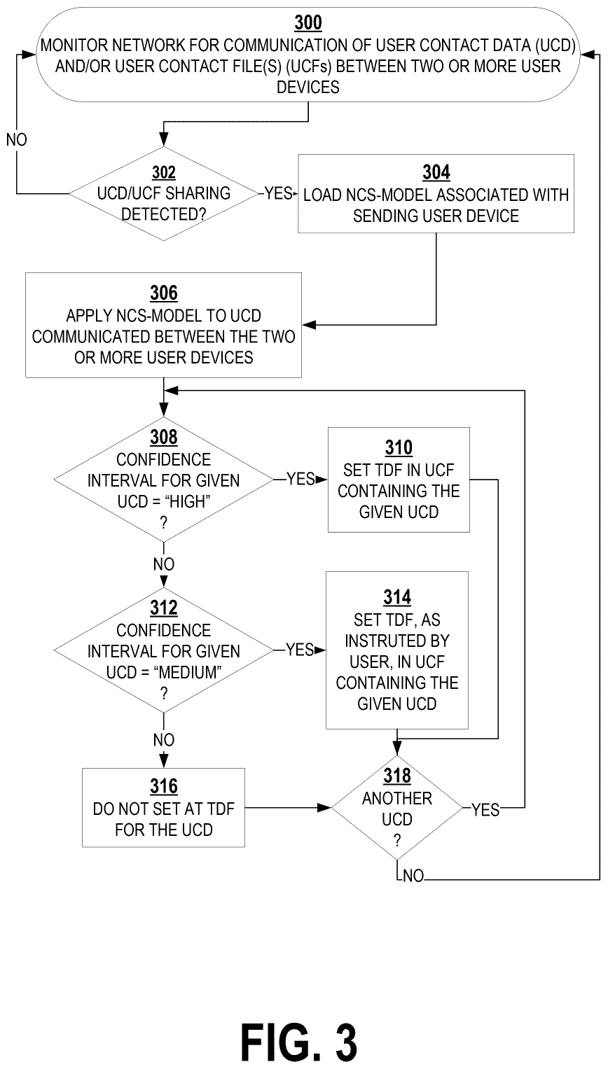

For at least one implementation, and as shown in FIG. 3, the NCMOs may include, per Operations 300 and 302, monitoring the network 140 for the communication of UCDs and/or UCFs between two or more UDs 102.

As per Operation 304 and for at least one implementation, the NCMOs may include loading an NCS-Model 134 associated with the UD 102, of the two or more UDs 102 participating in the communication, that is sending the UCF or UCD. If an NCS-Model 134 is not associated with the sending UD, a generic NCS-Model 134 may be utilized. Further, the NCS-Model 134 may be preloaded and Operation 304 may include selecting the pre-loaded NCS-Model 134 for use with respect to the given communication of the UCF/UCD. For at least one implementation, the NCS-Model(s) 134 may be preloaded, then loaded or otherwise loaded into one or more data stores (e.g., RAM) when the NCS-CE 136 is instantiated. The NCS-Model 134 may be preloaded onto the Cloud and provided for use by the one or more NCS processors instantiating a given instance of the NCS-CE 136 of which there may be one or many. Such many instances may execute operations in parallel, distributed, across multi-threads, or otherwise. It is to be appreciated that multiple NCS-Models 134 may exist and different models may be used for different UCDs, UCFs, UDs, or otherwise.

As per Operation 306 and for at least one implementation, the NCMOs may include applying the NCS-Model loaded (or otherwise accessed) per Operation 304 to the UCD identified in the communication of the UCDs and/or UCFs between the two or more user devices. Application of the NCS-Model may include utilizing any previously determined confidence intervals to identify whether a given instance of UCD does or does not contain TCD.

As per Operation 308 and for at least one implementation, the NCMOs may include determining if a confidence interval (as provided in the loaded/retrieved NCS-Model) for a given instance of UCD is “high.” If “Yes,” the process continues with Operation 310. If “NO,” the process continues with Operation 312.

As per Operation 310 and for at least one implementation, the NCMOs may include setting a TDF in the UCF, in which the given UCD arises. As discussed above the TDF may vary by type of UCD, UCF in which contained, and otherwise. For at least one implementation, the NCS-Model may specify one or more characteristics and/or settings associated with a given TDF.

As per Operation 312 and for at least one implementation, the NCMOs may include determining if the confidence interval for the given instance of UCD is “medium.” If “Yes,” the process continues with Operation 314. If “NO,” the process continues with Operation 316.

As per Operation 314 and for at least one implementation, the NCMOs may include setting a TDF in the UCF, in accordance with an instruction provided by the given user of one or more of the receiving user device(s) for the UCD. The user may instruct the TDF to be set, set for a given period, set for a default period, set in view of one or more current or future arising conditions, not set, or otherwise-as instructed by the given user. Further and for at least one implementation, if a user instruction is not received within a predetermined period, a default TDF may be specified for the given UCD. The default TDF may be specified in one or more user preferences, or otherwise. It is to be appreciated that different TDFs may be set for different instances of UCD in a given UCF, across multiple UCFs, across multiple user devices and otherwise. TDFs associated with a given UCD and/or for a given UCF may vary by user preference, or otherwise.

As per Operation 316 and for at least one implementation, the NCMOs may include not setting a TDF for the given UCD and/or for two or more UCDs in a given UCF communicated between the two or more user devices. It is to be appreciated that when a TDF is not set with respect to a given UCD, the given UCD is managed by a given user device in accordance with the processes and procedures utilized by a given instance of a UD-ContactsApp 106.

As per Operation 318 and for at least one implementation, the NCMOs may include determining if another instance of UCD has been identified in the communication between the two or more user devices. If “YES,” the process returns to Operation 308. If “NO,” the process returns to Operation 300 and continues until the NCS-CE 136 is terminated.

### Process for Managing Temporary Contacts

In accordance with at least one implementation of the present disclosure, a process for managing temporary contacts may include, as per Operation 400, receiving, at a first user (1UD) 102(1) device, user contact data (UCD) from a second user device (2UD) 102(2).

As per Operation 402 and for at least one implementation, the process may include determining whether some or all of the UCD is to be temporarily stored or non-temporarily stored by the 1UD 102(1) er device.

As per Operation 404 and for at least one implementation, when some of the UCD is to be temporarily stored, the process may include setting a TDF in a user contact file designating the UCD as temporary data.

As per Operation 406 and for at least one implementation, the process may include specifying a value for at least one TCD associated with the TDF.

As per Operation 408 and for at least one implementation, the process may include storing the at least one TDF in a 1UD-TCF.

As per Operation 410 and for at least one implementation, the process may include adding the TCF into the UCD.

As per Operation 412 and for at least one implementation, the process may include storing the UCD, as modified per Operation 410 or as received per Operation 400, in the 1UD-UCF.

As per Operation 414 and for at least one implementation, the process may include determining whether to update an associated NCS-CDF and/or NCS-TCF, as maintained by the NCS. If “YES,” the process may proceed to Operation 416. If “NO,” the process proceed to Operation 418.

As per Operation 416 and for at least one implementation, the process may include updating one or more of the NCS-CDF and the NCS-TCF with the UCD and TCF data generated and/or modified, as per one or more of the preceding operations.

As per Operation 418 and for at least one implementation, the process may end.

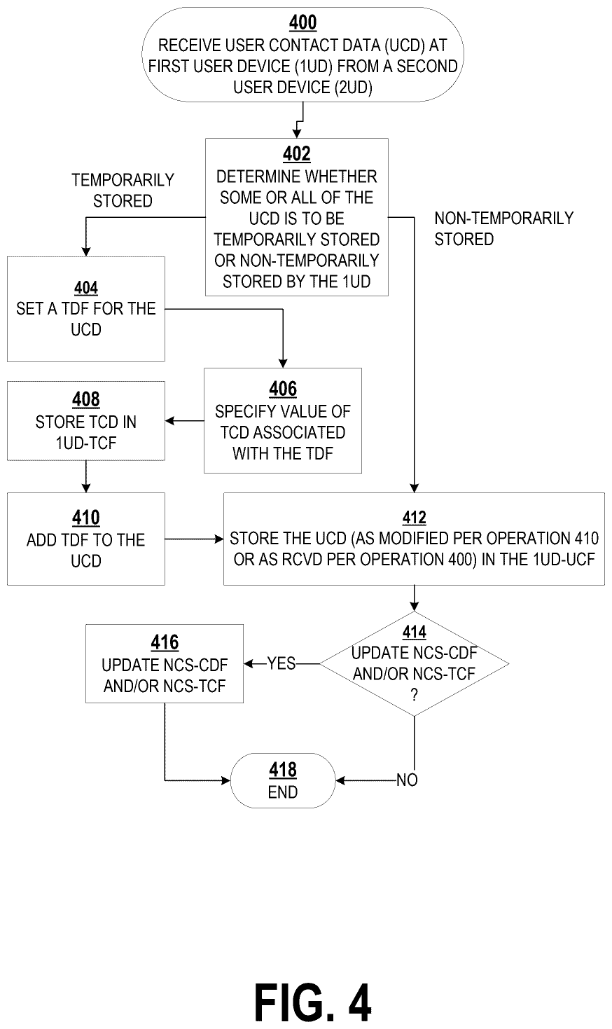

It is to be appreciated that the Operations depicted in FIGS. 2-4 may occur in the sequence as shown, and/or in any other sequence of operations including one more operations occurring in parallel.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

1. A user device comprising:
a user device data store (UDDS);
wherein the UDDS non-transitorily stores first computer instructions for instantiating a user device contacts application (UD-ContactsApp); and
wherein the UDDS non-transitorily stores second computer instructions for instantiating a user device temporary contacts application (UD-Temp); and
a user device processor (UDP) coupled to the UDDS;
wherein the UDP, when executing the first computer instructions, instantiates the UD-ContactsApp which further configures the user device (UD) to perform user device contact operations (UDCOs); and
wherein the UDP, when executing the second computer instructions instantiates the UD-Temp which further configures the UD to perform user device temporary contact management operations (UD-TCMOs); and\
wherein the UD-TCMOs include:
receiving user contact data (UCD) from a second user device (2UD);
storing, in the UDDS, the UCD in a first user device-user contact file (1UD-UCF);
receiving, from a network contacts server (NCS) coupled to the user device, a designation of the UCD as including temporary contacts data (TCD); and
designating the 1UD-UCF for automatic deletion, by the UDP and from the UDDS, at a future time;
wherein the NCS has utilized an NCS model (NCS-Model), generated by the NCS using one or more NCS neural processing units, artificial intelligence and machine learning, to determine real-time whether the UCD includes TCD;
wherein the NCS-Model generates a confidence interval designating the UCD as including TCD;
wherein, based on the confidence interval then identified for the UCD, the NCS real-time determines whether to set a temporary data flag (TDF) for the UCD; and
wherein the TDF identifies data in the UCD that includes TCD.

2. The user device claim 1,
wherein a user of the UD manually designates the UCD as temporary contacts data (TCD); and
wherein the TCD identifies at least one condition precedent specifying when the UCD is to be deleted.

3. The user device of claim 2,
wherein the at least one condition precedent is a passage of a given period.

4. (canceled)

5. The user device of claim 1,
wherein the UDCOs include generating the 1UD-UCF
wherein the UD-TCMOs further comprise configuring the UD-ContactsApp to include a data field for setting, in the 1UD-UCF, the TDF;
wherein the TDF identifies at least one instance of data in the UCD as containing TCD;
wherein the UD-TCMOs further comprise:
setting the TDF in the 1UD-UCF.

6. The user device of claim 5,
wherein the UD-TCMOs further comprise:
configuring the UDDS to manage the 1UD-TCF;
wherein the 1UD-TCF includes TCD; and
wherein the TCD is associated with the TDF; and
wherein the TCD identifies at least one condition precedent specifying when the 1UD-UCF is to be deleted.

7. The user device of claim 6,
wherein the at least one condition precedent is predetermined.

8. The user device of claim 6,
wherein the user sets the at least one condition precedent upon receiving the UCD.

9. The user device of claim 6,
wherein the at least one condition precedent identifies a future date and the future time; and
wherein the at least one condition precedent is determined prior to the UD receiving the UCD from the 2UD.

10. The user device of claim 6,
wherein the at least one condition precedent identifies a calendar event; and
wherein the UD-TCMOs further comprising:
automatically deleting the 1UD-UCF when the future calendar event has occurred or has been deleted.

11. (canceled)

12. The user device of claim 1,
wherein the NCS-Model was initially trained, during an initial training period, by monitoring utilization, disseminations, and deletions of the UCD by multiple other user devices, in a user set including multiple given users, over an initial monitoring period;
wherein the NCS-Model has undergone refinement training, after the initial monitoring period, by monitoring responses, by users of the multiple user devices, to queries of whether the UCD is to be designated or remain designated as TCD.

13. A non-transitory computer readable medium, having stored thereon computer instructions which, when executed by a user device processor (UDP), instantiates a user device temporary contacts application (UD-Temp) that configures a user device (UD) to perform user device temporary contact management operations (UD-TCMOs) comprising:
receiving user contact data (UCD) from a second user device (2UD);
storing, the UCD in a first user device-user contact file (1UD-UCF) in a user device data store (UDDS);
receiving, from a network contacts server (NCS) coupled to the user device, a designation of the UCD as including temporary contacts data (TCD);
designating the 1UD-UCF for automatic deletion, by the UDP and from the UDDS, at a future time;
wherein the NCS has utilized an NCS model (NCS-Model), generated by the NCS using one or more NCS neural processing units, artificial intelligence and machine learning, to determine real-time whether the UCD includes TCD;
wherein the NCS-Model generates a confidence interval designating the UCD as including TCD;
wherein, based on the confidence interval then identified for the UCD, the NCS real-time determines whether to set a temporary data flag (TDF) for the 1UD-UCF; and
wherein the TDF identifies data in the 1UD-UCF that includes TCD;
determining, based on the TDF, whether the 1UD-UCF includes temporary contact data (TCD); and
when the 1UD-UCF includes TCD,
designating the 1UD-UCF for automatic deletion, by the UD and from the UDDS, when a condition precedent occurs;
deleting the 1UD-UCF from the UDDS when the condition precedent occurs.

14. The non-transitory computer readable medium of claim 13,
wherein the condition precedent is a passage of a period of time.

15. (canceled)

16. The non-transitory computer readable medium of claim 13, having
further stored thereon additional computer instructions which, when executed by the UDP, instantiates a user device contact application (UD-ContactsApp) that configures the UD to perform user device contact operations (UDCOs) comprising:
managing a user device user contact file (UD-UCF);
wherein the UD-UCF includes at least one data field identifying at least one user characteristic; and
wherein the UD-TCMOs further comprise:
identifying the UD-UCF corresponding to the UCD.

17. The non-transitory computer readable medium of claim 16,
wherein the TDF corresponds to a temporary contact file (TCF);
wherein the TCF identifies at least one condition precedent; and
wherein upon occurrence of the condition precedent, the UD-Temp instructs the UD-ContactsApp to delete the UCD corresponding to the TCF.

18. The non-transitory computer readable medium of claim 17,
wherein the TCF is stored by a network contacts server coupled to the UD.

19. A process comprising:
receiving user contact data (UCD) at a first user device (1UD) from a second user device (2UD);
determining whether the UCD is to be temporarily stored by the 1UD in a user device data store (UDDS);
when temporarily stored,
setting, in the UDDS, a temporary data flag (TDF) for the UCD;
specifying, in the UDDS, a value for temporary contact data (TCD) associated with the TDF;
storing the TCD in a temporary contact file (TCF) in the UDDS;
adding the TDF to the UCD;
storing the UCD, with the TDF, in a first user device user contact file (1UD-UCF);
receiving, from a network contacts server (NCS) coupled to the user device, a designation of the UCD as including temporary contacts data (TCD);
wherein the NCS has utilized an NCS model (NCS-Model), generated by the NCS using one or more NCS neural processing units, artificial intelligence and machine learning, to determine real-time whether the UCD includes TCD;
wherein the NCS-Model generates a confidence interval designating the UCD as including TCD;
wherein, based on the confidence interval then identified for the UCD, the NCS real-time determines whether to specify a temporary data flag (TDF) for the UCD; and
wherein the TDF identifies data in the UCD that includes TCD;
determining, based on the TDF, whether the UCD includes TCD; and
designating the 1UD-UCF for automatic deletion, from the UDDS, at a future time.

20. The process of claim 19,
wherein the TCD specifies a condition precedent; and
wherein, upon an occurrence of the condition precedent, the 1UD-UCF is deleted from the user device.

21. The user device of claim 1,
wherein the confidence interval, for the given UCD, is one of “high,” “medium” or “low”;
wherein the confidence interval is incremented when a given user, in the user set, confirms that a given UCD is to be characterized as a TCD;
wherein the confidence interval is decremented when the given user, in the user set, does not confirm that the given UCD is to be characterized as a TCD;
wherein the given UCD has a “high” confidence interval when at least seventy five percent (75%) of the given users, in the user set, have confirmed that the given UCD is to be characterized as a TCD;
wherein the given UCD has a “medium” confidence interval when between at least thirty percent to seventy five percent (30-75%) of the given users, in the user set, have confirmed that the given UCD is to be characterized as a TCD; and
wherein the given UCD has a “low” confidence interval when less than thirty percent (30%) of the given users, in the user set, have confirmed that the given UCD is to be characterized as a TCD.

22. The non-transitory computer readable medium of claim 13,
wherein the confidence interval, for the given UCD, is one of “high,” “medium” or “low”;
wherein the confidence interval is incremented when a given user, in the user set, confirms that a given UCD is to be characterized as a TCD;
wherein the confidence interval is decremented when the given user, in the user set, does not confirm that the given UCD is to be characterized as a TCD;
wherein the given UCD has a “high” confidence interval when at least seventy five percent (75%) of the given users, in the user set, have confirmed that the given UCD is to be characterized as a TCD;
wherein the given UCD has a “medium” confidence interval when between at least thirty percent to seventy five percent (30-75%) of the given users, in the user set, have confirmed that the given UCD is to be characterized as a TCD; and
wherein the given UCD has a “low” confidence interval when less than thirty percent (30%) of the given users, in the user set, have confirmed that the given UCD is to be characterized as a TCD.

23. The process of claim 19,
wherein the confidence interval, for the given UCD, is one of “high,” “medium” or “low”;
wherein the confidence interval is incremented when a given user, in the user set, confirms that a given UCD is to be characterized as a TCD;
wherein the confidence interval is decremented when the given user, in the user set, does not confirm that the given UCD is to be characterized as a TCD;
wherein the given UCD has a “high” confidence interval when at least seventy five percent (75%) of the given users, in the user set, have confirmed that the given UCD is to be characterized as a TCD;
wherein the given UCD has a “medium” confidence interval when between at least thirty percent to seventy five percent (30-75%) of the given users, in the user set, have confirmed that the given UCD is to be characterized as a TCD; and
wherein the given UCD has a “low” confidence interval when less than thirty percent (30%) of the given users, in the user set, have confirmed that the given UCD is to be characterized as a TCD.
